(19) United States
(12) Patent Application Publication
(10) Pub. No.: US 2024/0222006 A1
(43) Pub. Date: Jul. 4, 2024

(54) NdFeB Magnet and Preparation Method Thereof

(71) Applicant: GANZHOU DMEGC RARE EARTH MAGNET CO.,LTD, Ganzhou City, Jiangxi (CN)

(72) Inventors: Longgui LI, Ganzhou City, Jiangxi (CN); Yan ZHANG, Ganzhou City, Jiangxi (CN); Chao LI, Ganzhou City, Jiangxi (CN); Baoxiang XIE, Ganzhou City, Jiangxi (CN)

(21) Appl. No.: 17/928,623

(22) PCT Filed: Sep. 2, 2021
(86) PCT No.: PCT/CN2021/116296

§ 371 Date: Nov. 30, 2022

(30) Foreign Application Priority Data
Jun. 10, 2021 (CN) 202110651274.7

(51) Int. Cl. H01F 41/02; B22F 3/16; B22F 3/24; B22F 9/02; B22F 9/04; C22C 38/00; C22C 38/06; C22C 38/10; C22C 38/12; C22C 38/14; C22C 38/16; H01F 1/057

(52) U.S. Cl. CPC H01F 41/0266; B22F 3/16; B22F 3/24; B22F 9/023; B22F 9/04; C22C 38/002; C22C 38/005; C22C 38/06; C22C 38/10; C22C 38/12; C22C 38/14; C22C 38/16; H01F 1/0577; B22F 2003/248; B22F 2202/05; B22F 2301/355; B22F 2304/10; B22F 2998/10; B22F 2999/00; C22C 2202/02

(57) ABSTRACT

The present disclosure provides an NdFeB magnet and a preparation method thereof. The preparation method includes the following steps: S1, mixing an alloy A and an alloy B for pulverizing treatment to obtain a mixed powder; S2, pressing and forming the mixed powder to obtain a pressed article; S3, successively performing sintering treatment and tempering treatment on the pressed article to obtain the NdFeB magnet. In this present disclosure, an alloy A and an alloy B based on a specific component content are used as raw materials, and subjected to multiple steps of pulverizing, forming, sintering and tempering treatment to prepare an NdFeB magnet. The NdFeB magnet of the present disclosure has a more enhanced coercive force and more stable remanence and magnetic performance without the addition of Dy and Tb. Meanwhile, the preparation method is simple to operate and thus, is more beneficial for volume production.

The present application is a National Stage of International Patent Application No: PCT/CN2021/116296 filed on Sep. 2, 2021, which is herein incorporated by reference in their entirety.

### TECHNICAL FIELD

The present disclosure relates to the field of NdFeB, and in particular to an NdFeB magnet and a preparation method thereof.

### BACKGROUND

Magnetic energy product is the most important in the technical indexes of magnetic materials. Magnetic energy product denotes the magnitude of energy of external magnetic field generated by unit volume of a magnet. High magnetic energy product means that a motor may make use of a smaller magnet to output higher power. Sintered NdFeB magnet is the permanent magnet material with the strongest overall magnetic performance in the world. With its excellent properties and cost performance superior to the conventional permanent magnet materials, sintered NdFeB magnet is widely applied in the fields, such as, energy, traffic, machinery, medical treatment, computer, home appliances and thus, plays an important role in national economy. Neodymium iron boron (NdFeB) is an important rare earth permanent magnetic material and featured by high magnetic energy product, high coercive force, light weight and low cost. NdFeB is the magnet with the highest cost performance up to now, and has been awarded “the king of magnet”. The appearance of NdFeB enables the magnetic devices to develop towards a high efficient, miniaturized and light-weight trend.

At present, there are two major methods to improve the coercive force of NdFeB magnet in industrial production: one is to add heavy rare earth Dy/Tb and the like to a master alloy directly by smelting, and to prepare a magnet with a conventional process. But after Dy/Tb is directly added to substitute Nd in the principal phase Nd₂Fe₁₄B, the generated new (Nd,Dy)₂Fe₁₄B and (Nd,Dy)₂Fe₁₄B have an anisotropism greater than that of the principal phase, thereby obviously improving the coercive force of the sintered magnet. Two is a grain boundary diffusion process. The magnet sample prepared by the grain boundary diffusion process is limited by the thickness of a magnet. For example, the patent (publication No.: 201810154877.4) “high-performance sintered Ndfeb magnet and preparation method thereof” and the patent (publication No.: 201210419107.0) “sintered Ndfeb magnet and preparation method thereof” did not relate to a production method of a high-performance heavy rare earth-free NdFeB magnet.

The content of Dy and Tb is the key to determine the cost of a high-performance sintered Ndfeb magnet material. But in recent years, the cost of heavy rare earth has increased, and how to improve the coercive force of an NdFeB magnet with a little addition or no addition of Dy and Tb has become a research priority. Effects of post-sinter annealing on the microstructure and magnetic properties of Nd—Fe—B sintered magnets with Nd—Ga intergranular addition [J], Chinese Physics B, 2021. The academic paper has disclosured that the content (especially the content of Nd and Ga) of each component in alloy, and hydrogen decrepitation temperature are regulated and controlled, thus promoting the improvement of coercive force of the formed sintered magnet to some extent. However, the principal phase Re₂T₁₄B is mainly formed preferentially and Re₆Fe₁₃Ga phase is formed secondly in this literature; the formation of the Re₆Fe₁₃Ga phase requires strict conditions, which is not beneficial to volume production. Furthermore, the sintered magnet formed by the above method has slightly enhanced coercive force, and poor remanence and magnetic performance stability.

Based on this, it is necessary to provide an NdFeB magnet which has a simpler preparation process, higher improvement of coercive force, and more stable remanence and magnetic performance, and is more beneficial to volume production.

### SUMMARY

The main objective of the present disclosure is to provide an NdFeB magnet and a preparation method thereof, thus solving the problems in the prior art, namely, when the coercive force of an NdFeB magnet is improved with a little addition or no addition of Dy and Tb, it is not beneficial to volume production; the formed sintered magnet has slightly enhanced coercive force, and poor residual magnetism and poor magnetic performance stability.

To achieve the above objective, according to one aspect of the present disclosure, a preparation method of an NdFeB magnet is provided. The preparation method includes the following steps: S1, mixing an alloy A and an alloy B for pulverizing treatment to obtain a mixed powder; S2, pressing and forming the mixed powder to obtain a pressed article; S3, successively performing sintering treatment and tempering treatment on the pressed article to obtain the NdFeB magnet; where, raw material components of the alloy A contain 28-35 wt % Re, 64-71.2 wt % T and 0.8-1.0 wt % B by weight percentage; where, Re is one or more of La, Ce, Pr or Nd; and T is one or more of Fe, Co, Al, Si, Cu, Nb, Zr and Ga; raw material components of the alloy B contain 40-60 wt % Re, 39.2-59.5 wt % T and 0.5-0.8 wt % B by weight percentage; where, Re is one or more of La, Ce, Pr or Nd, T contains Fe and Ga; and meanwhile, T further contains one or more of Co, Cu, Nb, and Zr.

Further, the alloy B has a use amount accounting for 1-10% of the weight of the alloy A.

Further, the raw material components of the alloy B contain 40-60 wt % Re, 0-2 wt % Co, 3-10 wt % Cu, 3-10 wt % Ga, 0-0.5 wt % Nb and/or Zr, 0.5-0.8 wt % B and a balance of Fe.

Further, the raw material components of the alloy A contain: 30-32 wt % Nd, 1.0-2.0 wt % Co, 0.05-0.1 wt % Cu, 0.3-0.8 wt % Al, 0.1-0.15 wt % Ga, 0.12-0.15 wt % Zr, 0.9-0.92 wt % B and the balance of Fe; the raw materials of the alloy B contain: 40-50 wt % Nd, 1.0-1.5 wt % Co, 5-8 wt % Cu, 0.1-0.4 wt % Al, 5-8 wt % Ga, 0.2-0.3 wt % Nb, 0.65-0.75 wt % B and the balance of Fe.

Preferably, the raw material components of the alloy A contain: 32 wt % Nd, 1.5 wt % Co, 0.1 wt % Cu, 0.8 wt % Al, 0.1 wt % Ga, 0.15 wt % Zr, 0.9 wt % B and the balance of Fe; the raw material components of the alloy B contain: 50 wt % Nd, 1.0 wt % Co, 6 wt % Cu, 0.4 wt % Al, 6 wt % Ga, 0.3 wt % Nb, 0.75 wt % B and the balance of Fe; or, the raw material components of the alloy A contain: 31.5 wt % Nd, 1.5 wt % Co, 0.1 wt % Cu, 0.6 wt % Al, 0.1 wt % Ga, 0.15 wt % Zr, 0.9 wt % B and the balance of Fe; the raw material components of the alloy B contain: 45 wt % Nd, 1.0 wt % Co, 5 wt % Cu, 0.1 wt % Al, 5 wt % Ga, 0.3 wt % Nb, 0.7 wt % B and the balance of Fe.

Further, the mixed powder has a mean particle size of 2.8-3.0 μm.

Further, the sintering treatment has a treatment temperature of 1000-1100° C. and a treatment time of 5-10 h.

Further, the tempering treatment includes a primary tempering treatment and a secondary tempering treatment performed in order; preferably, the primary tempering treatment has a treatment temperature of 880-920° C. and a treatment time of 2-4 h; preferably, the secondary tempering treatment has a treatment temperature of 450-550° C. and a treatment time of 4-6 h.

Further, before the pulverizing treatment, the preparation method further contains a step of mixing the alloy A and the alloy B, and performing hydrogen decrepitation treatment and dehydrogenafion treatment successively; preferably, the dehydrogenafion treatment has a treatment temperature of 450-500° C. and a treatment time of 5-10 h; preferably, the mixed powder has a hydrogen content of 600-1200 ppm and an oxygen content of 1000-1500 ppm.

Further, in the pressing and forming process, the mixed powder is pressed and formed in an oriented magnetic field, and the oriented magnetic field has a magnetic field intensity is not less than 1.4 T.

To achieve the above objective, according to another aspect of the present disclosure, an NdFeB magnet is provided. The NdFeB magnet is prepared by the above preparation method.

In this present disclosure, an alloy A and an alloy B based on a specific component content are used as raw materials, and subjected to multiple steps of pulverizing, forming, sintering and tempering treatment to prepare an NdFeB magnet. The Re₈Fe₁₃Ga phase in the magnet may be doped between the surfaces of crystal boundary of the principal phase Re₂T₁₄B more evenly and stably, thus forming an isolating layer. Further, the NdFeB magnet of the present disclosure has a more enhanced coercive force and more stable remanence and magnetic performance without the addition of Dy and Tb. Meanwhile, the preparation method is simple to operate and thus, is more beneficial for volume production.

### BRIEF DESCRIPTION OF THE DRAWINGS

Drawings of the description constituting a part of the present application are used to provide a further understanding to the present disclosure. Schematic examples and description thereof in the present disclosure are used to explain the present disclosure, but not intended to limit the present disclosure improperly. In the drawings:

FIG. 1 is a flow diagram showing a preparation method of an NdFeB magnet of the present disclosure.

### DETAILED DESCRIPTION OF THE EMBODIMENTS

It should be indicated that the examples and features of the examples of the present application may be combined with each other without no conflict. The present disclosure will be described with reference to the examples below.

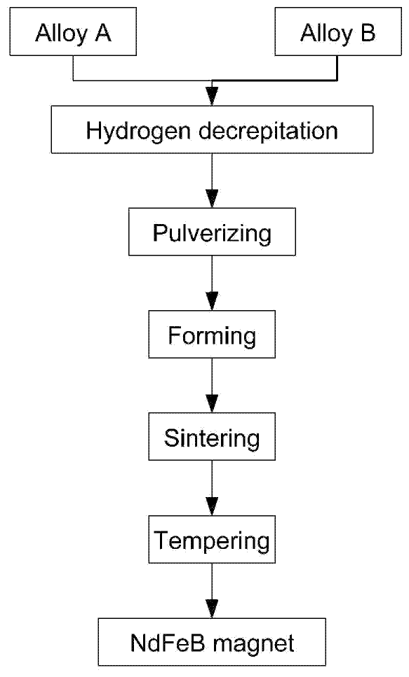

As described in the background part, there are the problems in the prior art, namely, when the coercive force of an NdFeB magnet is improved with a little addition or no addition of Dy and Tb, it is not beneficial to volume production; and the formed sintered magnet has slightly enhanced coercive force, and poor remanence and poor magnetic performance stability. To solve such a problem, the present disclosure provides a preparation method of an NdFeB magnet, as shown in FIG. 1, the preparation method includes the following steps: S1, mixing an alloy A and an alloy B for pulverizing treatment to obtain a mixed powder; S2, pressing and forming the mixed powder to obtain a pressed article; S3, successively performing sintering treatment and tempering treatment on the pressed article to obtain the NdFeB magnet; where, raw material components of the alloy A contain 28-35 wt % Re, 64-71.2 wt % T and 0.8-1.0 wt % B by weight percentage; where, Re is one or more of La, Ce, Pr or Nd; and T is one or more of Fe, Co, Al, Si, Cu, Nb, Zr and Ga; raw material components of the alloy B contain 40-60 wt % Re, 39.2-59.5 wt % T and 0.5-0.8 wt % B by weight percentage; where, Re is one or more of La, Ce, Pr or Nd, T contains Fe and Ga; and meanwhile, T further contains one or more of Co, Cu, Nb, and Zr.

In this present disclosure, an alloy A and an alloy B based on the above specific component content are used as raw materials, and subjected to multiple steps of pulverizing, forming, sintering and tempering treatment to prepare an NdFeB magnet. The Re₆Fe₁₃Ga phase in the magnet may be doped between the surfaces of crystal boundary of the principal phase Re₂T₁₄B more evenly and stably, thus forming an isolating layer. Further, the NdFeB magnet of the present disclosure has a more enhanced coercive force and more stable remanence and magnetic performance without the addition of Dy and Tb. Meanwhile, the preparation method is simple to operate and thus, is more beneficial for volume production.

It should be indicated that the above alloys A and B are prepared by conventionally smelting the raw materials; the specific smelting process is commonly known in the art, for example, a resin transfer molding technology (RTM), and a vacuum rapid hardening smelting process.

In view of further improving the doping uniformity and stability of the Re₆Fe₁₃Ga phase, the alloy B preferably has a use amount accounting for 1-10% of the weight of the alloy A. The NdFeB magnet has more enhanced coercive force and better magnetic performance stability within such a scope. Moreover, the preparation method is simple to operate and thus, is more beneficial for volume production.

For the purpose of further improving the coercive force of the magnet, the raw material components of the alloy B preferably contain 40-60 wt % Re, 0-2 wt % Co, 3-10 wt % Cu, 3-10 wt % Ga, 0-0.5 wt % Nb and/or Zr, 0.5-0.8 wt % B and a balance of Fe.

In a preferred embodiment, each component content in the alloy A is as follows: 30-32 wt % Nd, 1.0-2.0 wt % Co, 0.05-0.1 wt % Cu, 0.3-0.8 wt % Al, 0.1-0.15 wt % Ga, 0.12-0.15 wt % Zr, 0.9-0.92 wt % B and the balance of Fe; each component content in the alloy B is as follows: 40-50 wt % Nd, 1.0-1.5 wt % Co, 5-8 wt % Cu, 0.1-0.4 wt % Al, 5-8 wt % Ga, 0.2-0.3 wt % Nb, 0.65-0.75 wt % B and the balance of Fe. Based on this, the magnet has more significantly enhanced coercive force, and has more stable remanence and magnetic performance.

To further improve the coercive force of the magnet, and remanence and magnetic performance stability, more preferably, each component content in the alloy A is as follows: 32 wt % Nd, 1.5 wt % Co, 0.1 wt % Cu, 0.8 wt % Al, 0.1 wt % Ga, 0.15 wt % Zr, 0.9 wt % B and the balance of Fe; each component content in the alloy B is as follows: 50 wt % Nd, 1.0 wt % Co, 6 wt % Cu, 0.4 wt % Al, 6 wt % Ga, 0.3 wt % Nb, 0.75 wt % B and the balance of Fe; or, each component content in the alloy A is as follows: 31.5 wt % Nd, 1.5 wt % Co, 0.1 wt % Cu, 0.6 wt % Al, 0.1 wt % Ga, 0.15 wt % Zr, 0.9 wt % B and the balance of Fe; each component content in the alloy B is as follows: 45 wt % Nd, 1.0 wt % Co, 5 wt % Cu, 0.1 wt % Al, 5 wt % Ga, 0.3 wt % Nb, 0.7 wt % B and the balance of Fe.

Preferably, the mixed powder has a mean particle size of 2.8-3.0 μm, and 50% powder has a particle size less than 3.5 μm in normal distribution. In this way, alloys A and B may be mixed more evenly, which may further improve the subsequent forming efficiency, thereby promoting the magnet to achieve more stable magnetic performance.

For the purpose of further improving the magnetic performance stability of the NdFeB magnet, the sintering treatment has a treatment temperature of 1000-1100° C. and a treatment time of 5-10 h.

For the purpose of further balancing the doping stability and uniformity of the Re₆Fe₁₃Ga phase, preferably, the tempering treatment includes a primary tempering treatment and a secondary tempering treatment performed in order; preferably, the primary tempering treatment has a treatment temperature of 880-920° C. and a treatment time of 2-4 h; preferably, the secondary tempering treatment has a treatment temperature of 450-550° C. and a treatment time of 4-6 h.

Further, before the pulverizing treatment, the preparation method further includes a step of mixing the alloy A and the alloy B, and performing hydrogen decrepitation treatment and dehydrogenafion treatment successively; preferably, the dehydrogenafion treatment has a treatment temperature of 450-500° C. and a treatment time of 5-10 h; preferably, the mixture of alloys A and B may be pre-crushed first in the hydrogen decrepitation treatment of the mixed powder, thus further improving the subsequent pulverizing efficiency. After hydrogen decrepitation and based on the above dehydrogenafion treatment, the hydrogen content and the oxygen content in the mixed powder may be respectively controlled within 600-1200 ppm and 1000-1500 ppm better.

Preferably, in the pressing and forming process, the mixed powder is pressed and formed in an oriented magnetic field, and the oriented magnetic field has a magnetic field intensity is not less than 1.4 T. In this way, the pressed article is more compact, and alloys A and B in the article are mixed more evenly, such that the magnet has more significantly enhanced intrinsic coercive force, more superior remanence and maximum magnetic energy product, and more stable magnetic performance after the subsequent sintering and tempering treatment.

The present disclosure further provides an NdFeB magnet, and the NdFeB magnet is prepared by the above preparation method of the NdFeB magnet.

Based on the various reasons of the preceding text, the NdFeB magnet of the present disclosure has significantly enhanced coercive force, and has more stable remanence and magnetic performance without any addition of Dy/Tb, and is more beneficial to volume production.

The present application will be further described in detail with reference to detailed examples, but these examples are not construed as limiting the protection scope of the present application.

### Performance Test:

(1) Remanence performance (Br) test a permanent magnet nondestructive testing instrument NIM-10000 was taken.

(2) Intrinsic coercive force (Hcj): a permanent magnet nondestructive testing instrument NIM-10000 was taken.

(3) Maximum magnetic energy product (BHₘₐₓ): a permanent magnet nondestructive testing instrument NIM-10000 was taken.

### Example 1

A casting alloy piece A was prepared according to a formula of 31.5 wt % (Nd, Pr), 1.5 wt % Co, 0.1 wt % Cu, 0.6 wt % Al, 0.1 wt % Ga, 0.15 wt % Zr, 0.90 wt % B and a balance of Fe by weight. A casting alloy piece B was prepared according to a formula of 45 wt % (Nd, Pr), 1.0 wt % Co, 5 wt % Cu, 0.1 wt % Al, 5 wt % Ga, 0.3 wt % Nb, 0.70 wt % B and a balance of Fe by weight via a vacuum rapid hardening smelting process. In the alloy A and alloy B, a weight ratio of Nd to Pr was 2:8.

The alloy A and alloy B were mixed (the alloy B had a use amount accounting for 5% of the weight of the alloy A), and successively subjected to hydrogen decrepitation, dehydrogenafion and pulverizing treatment, thus obtaining a mixed powder. The hydrogen decrepitation and dehydrogenafion had a treatment temperature of 480° C. and dehydrogenafion treatment time of 6 h; after dehydrogenation, the powder had a hydrogen content of 980 ppm and an oxygen content of 1100 ppm. The hydrogen decrepitated powder was pulverized via airflow, and the particle size of the mixed powder accorded with the normal distribution, and the mean particle size was 2.8 μm; 50% powder had a particle size less than 3.25 μm in normal distribution.

The mixed powder was pressed and formed into a 60×35×40 (mm) block blank in an oriented magnetic field (≥1.4 T), and the blank was put to a high-vacuum sintering furnace and sintered for 7 h at 1070° C., and subjected to a primary tempering treatment for 3 h at 900° C. and a secondary tempering treatment for 5 h at 510° C. in order, and prepared into an NdFeB magnet. A ϕ10×10 (mm) standard sample was taken for test and the test results were shown in Table 1 below Table 1

TABLE 1

| | | | Maximum |
|---|---|---|---|
| | | | magnetic |
| | | Intrinsic | energy |
| | Remanence | coercive | product |
| Source of | Br | force Hcj | (BH)max |
| magnet | (kGs) | (kOe) | (MGOe) |
| Example 1 | 13.12 | 21.6 | 40.75 |
| Alloy A | 13.5 | 17.2 | 43.56 |
| Alloy B | 10.2 | 11.2 | 29.15 |

### Example 2

Example 2 differed from Example 1 only in that the use amount of the alloy B was 12% of the weight of the alloy A. A ϕ10×10 (mm) standard sample was taken for test and the test results were shown in Table 2 below

TABLE 2

| | | | Maximum |
|---|---|---|---|
| | | Intrinsic | magnetic |
| | | coercive | energy |
| | Remanence | force | product |
| Source of | Br | Hcj | (BH)max |
| magnet | (kGs) | (kOe) | (MGOe) |
| Example 2 | 12.65 | 18.9 | 37.23 |
| Alloy A | 13.5 | 17.2 | 43.56 |
| Alloy B | 10.2 | 11.2 | 29.15 |

### Example 3

A casting alloy piece A was prepared according to a formula of 30 wt % (Nd, Pr), 1.0 wt % Co, 0.05 wt % Cu, 0.3 wt % Al, 0.1 wt % Ga, 0.12 wt % Zr, 0.92 wt % B and a balance of Fe by weight. A casting alloy piece B was prepared according to a formula of 40 wt % (Nd, Pr), 1.0 wt % Co, 8 wt % Cu, 0.1 wt % Al, 8 wt % Ga, 0.2 wt % Nb, 0.65 wt % B and a balance of Fe by weight via a vacuum rapid hardening smelting process. In the alloy A and alloy B, a weight ratio of Nd to Pr was 2:8.

The alloy A and alloy B ware mixed (the alloy B had a use amount accounting for 6% of the weight of the alloy A), and successively subjected to hydrogen decrepitation, dehydrogenafion and pulverizing treatment, thus obtaining a mixed powder. The hydrogen decrepitation and dehydrogenafion had a treatment temperature of 470° C. and dehydrogenafion treatment time of 6 h; after dehydrogenation, the powder had a hydrogen content of 1020 ppm and an oxygen content of 1060 ppm. The hydrogen decrepitated powder was pulverized via airflow, and the particle size of the mixed powder accorded with the normal distribution, and the mean particle size was 2.95 μm; 50% powder had a particle size less than 3.42 μm in normal distribution.

The mixed powder was pressed and formed into a 70×50×35 (mm) block blank in an oriented magnetic field (≥1.4 T), and the blank was put to a high-vacuum sintering furnace and sintered for 7 h at 1060° C., and subjected to a primary tempering treatment for 3 h at 900° C. and a secondary tempering treatment for 5 h at 510° C., and prepared into an NdFeB magnet. A ϕ10×10 (mm) standard sample was taken for test and the test results were shown in Table 3 below

TABLE 3

| | | Intrinsic | Maximum |
|---|---|---|---|
| | | coercive | magnetic |
| | | force | energy |
| | Remanence | Hcj | product |
| Source of | Br | (kOe) | (BH)max |
| magnet | (kGs) | (kOe) | (MGOe) |
| Example 3 | 13.82 | 17.56 | 47.52 |
| Alloy A | 14.2 | 13.5 | 51.27 |
| Alloy B | 10.85 | 12.5 | 30.24 |

### Example 4

Example 4 differed from Example 3 only in that the use amount of the alloy A was 11% of the weight of the alloy B. A ϕ10×10 (mm) standard sample was taken for test and the test results ware shown in Table 4 below

TABLE 4

| | | Intrinsic | Maximum |
|---|---|---|---|
| | | coercive | magnetic |
| | | force | energy |
| | Remanence | Hcj | product |
| Source of | Br | (kOe) | (BH)max |
| magnet | (kGs) | (kOe) | (MGOe) |
| Example 4 | 13.58 | 16.52 | 46.65 |
| Alloy A | 14.2 | 13.5 | 51.27 |
| Alloy B | 10.85 | 12.5 | 30.24 |

### Example 5

A casting alloy piece A was prepared according to a formula of 32 wt % (Nd, Pr), 1.5 wt % Co, 0.1 wt % Cu, 0.8 wt % Al, 0.1 wt % Ga, 0.15 wt % Zr, 0.90 wt % B and a balance of Fe by weight via vacuum rapid hardening smelting. A casting alloy piece B was prepared according to a formula of 50 wt % (Nd, Pr), 1.0 wt % Co, 6 wt % Cu, 0.4 wt % Al, 6 wt % Ga, 0.3 wt % Nb, 0.75 wt % B and a balance of Fe by weight via vacuum rapid hardening smelting. In the alloy A and alloy B, a weight ratio of Nd to Pr was 2:8.

The alloy A and alloy B were mixed (the alloy B had a use amount accounting for 8% of the weight of the alloy A), and successively subjected to hydrogen decrepitation, dehydrogenafion and pulverizing treatment, thus obtaining a mixed powder. The hydrogen decrepitation and dehydrogenafion had a treatment temperature of 490° C. and dehydrogenafion treatment time of 6 h; after dehydrogenation, the powder had a hydrogen content of 980 ppm and an oxygen content of 1050 ppm. The hydrogen decrepitated powder was pulverized via airflow, and the particle size of the mixed powder accorded with the normal distribution, and the mean particle size was 2.87 μm; 50% powder had a particle size less than 3.28 μm in normal distribution.

The mixed powder was pressed and formed into a 70×50×35 (mm) block blank in an oriented magnetic field (≥1.4 T), and the blank was put to a high-vacuum sintering furnace and sintered for 7 h at 1080° C., and subjected to a primary tempering treatment for 3 h at 900° C. and a secondary tempering treatment for 5 h at 510° C., and prepared into an NdFeB magnet. A ϕ10×10 (mm) standard sample was taken for test and the test results were shown in Table 5 below

TABLE 5

| | | Intrinsic | Maximum |
|---|---|---|---|
| | | coercive | magnetic |
| | | force | energy |
| | Remanence | Hcj | product |
| Source of | Br | (kOe) | (BH)max |
| magnet | (kGs) | (kOe) | (MGOe) |
| Example 5 | 12.85 | 22.35 | 39.86 |
| Alloy A | 13.21 | 18.25 | 41.82 |
| Alloy B | 10.12 | 13.65 | 27.12 |

### Example 6

Example 6 differed from Example 5 only in that the use amount of the alloy B was 13% of the weight of the alloy A. A ϕ10×10 (mm) standard sample was taken for test and the test results were shown in Table 6 below

TABLE 6

| | | Intrinsic | Maximum |
|---|---|---|---|
| | | coercive | magnetic |
| | | force | energy |
| | Remanence | Hcj | product |
| Source of | Br | (kOe) | (BH)max |
| magnet | (kGs) | (kOe) | (MGOe) |
| Example 6 | 12.57 | 19.75 | 37.75 |
| Alloy A | 13.21 | 18.25 | 41.82 |
| Alloy B | 10.12 | 13.65 | 27.12 |

### Comparative Example 1

Comparative Example 1 differed from Example 1 in that raw materials were together prepared into an alloy, and then an NdFeB magnet was manufactured. Specifically: an alloy C was prepared according to a formula of 32.14 wt % (Nd, Pr), 1.48 wt % Co, 0.33 wt % Cu, 0.58 wt % Al, 0.24 wt % Ga, 0.16 wt % Zr, 0.89 wt % B and a balance of Fe by weight via vacuum rapid hardening smelting, and then, the alloy C was subjected to hydrogen decrepitation, dehydrogenafion and pulverizing treatment to obtain a powder. The hydrogen decrepitation and dehydrogenafion had a treatment temperature of 480° C. and dehydrogenafion treatment time of 6 h; after dehydrogenation, the powder had a hydrogen content of 980 ppm and an oxygen content of 1100 ppm. The hydrogen decrepitated powder was pulverized via airflow, and the particle size of the mixed powder accorded with the normal distribution, and the mean particle size was 2.8 μm; 50% powder had a particle size less than 3.25 μm in normal distribution. In the alloy A and alloy B, a weight ratio of Nd to Pr was 2:8.

The powder was pressed and formed into a 60×35×40 (mm) block blank in an oriented magnetic field (≥1.4 T), and the blank was put to a high-vacuum sintering furnace and sintered for 7 h at 1070° C., and subjected to a primary tempering treatment for 3 h at 900° C. and a secondary tempering treatment for 5 h at 510° C. in order, and prepared into an NdFeB magnet. A ϕ10×10 (mm) standard sample was taken for test and the test results were shown in Table 7 below.

### Comparative Example 2

Comparative Example 2 differed from Example 3 in that raw materials were together prepared into an alloy, and then an NdFeB magnet was manufactured. Specifically: a casting alloy piece D was prepared according to a formula of 30.57 wt % (Nd, Pr), 1.0 wt % Co, 0.5 wt % Cu, 0.29 wt % Al, 0.55 wt % Ga, 0.11 wt % Zr, 0.90 wt % B and a balance of Fe by weight via vacuum rapid hardening smelting, and then, the alloy D was subjected to hydrogen decrepitation for discharge, dehydrogenafion and pulverizing treatment to obtain a powder. The hydrogen decrepitation and dehydrogenafion had a treatment temperature of 470° C. and dehydrogenafion treatment time of 6 h; after dehydrogenation, the powder had a hydrogen content of 1020 ppm and an oxygen content of 1060 ppm. The hydrogen decrepitated powder was pulverized via airflow, and the particle size of the mixed powder accorded with the normal distribution, and the mean particle size was 2.95 μm; 50% powder had a particle size less than 3.42 μm in normal distribution. In the alloy A and alloy B, a weight ratio of Nd to Pr was 2:8.

The powder was pressed and formed into a 70×50×35 (mm) block blank in an oriented magnetic field (≥1.4 T), and the blank was put to a high-vacuum sintering furnace and sintered for 7 h at 1060° C., and subjected to a primary tempering treatment for 3 h at 900° C. and a secondary tempering treatment for 5 h at 510° C. in order, and prepared into an NdFeB magnet. A ϕ10×10 (mm) standard sample was taken for test and the test results were shown in Table 7 below Comparative Example 3 Comparative Example 3 differed from Example 5 in that raw materials were together prepared into an alloy, and then an NdFeB magnet was manufactured. Specifically: a casting alloy piece E was prepared according to a formula of 33.33 wt % (Nd, Pr), 1.46 wt % Co, 0.54 wt % Cu, 0.77 wt % Al, 0.54 wt % Ga, 0.14 wt % Zr, 0.02 wt % Nb, 0.89 wt % B and a balance of Fe by weight via vacuum rapid hardening smelting, and then, the alloy E was subjected to hydrogen decrepitation for discharge, dehydrogenafion and pulverizing treatment to obtain a powder. The hydrogen decrepitation and dehydrogenafion had a treatment temperature of 490° C. and dehydrogenafion treatment time of 6 h; after dehydrogenation, the powder had a hydrogen content of 980 ppm and an oxygen content of 1050 ppm. The hydrogen decrepitated powder was pulverized via airflow, and the particle size of the mixed powder accorded with the normal distribution, and the mean particle size was 2.87 μm; 50% powder had a particle size less than 3.28 μm in normal distribution. In the alloy A and alloy B, a weight ratio of Nd to Pr was 2:8.

The powder was pressed and formed into a 70×50×35 (mm) block blank in an oriented magnetic field (≥1.4 T), and the blank was put to a high-vacuum sintering furnace and sintered for 7 h at 1080° C., and subjected to a primary tempering treatment for 3 h at 900° C. and a secondary tempering treatment for 5 h at 510° C. in order, and prepared into an NdFeB magnet. A ϕ10×10 (mm) standard sample was taken for test and the test results were shown in Table 7 below

TABLE 7

| | | Intrinsic | Maximum |
|---|---|---|---|
| | | coercive | magnetic |
| | | force | energy |
| | Remanence | Hcj | product |
| Source of | Br | (kOe) | (BH)max |
| magnet | (kGs) | (kOe) | (MGOe) |
| Comparative | 13.05 | 19.87 | 40.32 |
| Example 1 | | | |
| Comparative | 13.71 | 16.93 | 46.35 |
| Example 2 | | | |
| Comparative | 12.68 | 20.92 | 38.27 |
| Example 3 | | | |

1. A preparation method of an NdFeB magnet, comprising the following steps:
S1, mixing an alloy A and an alloy B for pulverizing treatment to obtain a mixed powder;
S2, pressing and forming the mixed powder to obtain a pressed article;
S3, successively performing sintering treatment and tempering treatment on the pressed article to obtain the NdFeB magnet; wherein,
raw material components of the alloy A comprise 28-35 wt % Re, 64-71.2 wt % T and 0.8-1.0 wt % B by weight percentage; wherein, Re is one or more of La, Ce, Pr or Nd; and T is one or more of Fe, Co, Al, Si, Cu, Nb, Zr and Ga;
raw material components of the alloy B comprise 40-60 wt % Re, 39.2-59.5 wt % T and 0.5-0.8 wt % B by weight percentage; wherein, Re is one or more of La, Ce, Pr or Nd, T comprises Fe and Ga; and meanwhile, T further comprises one or more of Co, Cu, Nb, and Zr.

2. The preparation method according to claim 1, wherein the alloy B has a use amount accounting for 1-10% of the weight of the alloy A.

3. The preparation method according to claim 1, wherein the raw material components of the alloy A comprise 40-60 wt % Re, 0-2 wt % Co, 3-10 wt % Cu, 3-10 wt % Ga, 0-0.5 wt % Nb and/or Zr, 0.5-0.8 wt % B and a balance of Fe.

4. The preparation method according to claim 1, wherein the raw material components of the alloy A comprise: 30-32 wt % Nd, 1.0-2.0 wt % Co, 0.05-0.1 wt % Cu, 0.3-0.8 wt % Al, 0.1-0.15 wt % Ga, 0.12-0.15 wt % Zr, 0.9-0.92 wt % B and the balance of Fe; the raw materials of the alloy B comprise: 40-50 wt % Nd, 1.0-1.5 wt % Co, 5-8 wt % Cu, 0.1-0.4 wt % Al, 5-8 wt % Ga, 0.2-0.3 wt % Nb, 0.65-0.75 wt % B and the balance of Fe; preferably,
the raw material components of the alloy A comprise: 32 wt % Nd, 1.5 wt % Co, 0.1 wt % Cu, 0.8 wt % Al, 0.1 wt % Ga, 0.15 wt % Zr, 0.9 wt % B and the balance of Fe; the raw material components of the alloy B comprise: 50 wt % Nd, 1.0 wt % Co, 6 wt % Cu, 0.4 wt % Al, 6 wt % Ga, 0.3 wt % Nb, 0.75 wt % B and the balance of Fe; or,
the raw material components of the alloy A comprise: 31.5 wt % Nd, 1.5 wt % Co, 0.1 wt % Cu, 0.6 wt % Al, 0.1 wt % Ga, 0.15 wt % Zr, 0.9 wt % B and the balance of Fe; the raw material components of the alloy B comprise: 45 wt % Nd, 1.0 wt % Co, 5 wt % Cu, 0.1 wt % Al, 5 wt % Ga, 0.3 wt % Nb, 0.7 wt % B and the balance of Fe.

5. The preparation method according to claim 1, wherein the mixed powder has a mean particle size of 2.8-3.0 μm.

6. The preparation method according to claim 1, wherein the sintering treatment has a treatment temperature of 1000-1100° C. and a treatment time of 5-10 h.

7. The preparation method according to claim 1, wherein the tempering treatment comprises a primary tempering treatment and a secondary tempering treatment performed in order; preferably, the primary tempering treatment has a treatment temperature of 880-920° C. and a treatment time of 2-4 h; preferably, the secondary tempering treatment has a treatment temperature of 450-550° C. and a treatment time of 4-6 h.

8. The preparation method according to claim 1, wherein before the pulverizing treatment, the preparation method further comprises a step of mixing the alloy A and the alloy B, and performing hydrogen decrepitation treatment and dehydrogenafion treatment successively; preferably, the dehydrogenafion treatment has a treatment temperature of 450-500° C. and a treatment time of 5-10 h; preferably, the mixed powder has a hydrogen content of 600-1200 ppm and an oxygen content of 1000-1500 ppm.

9. The preparation method according to claim 1, wherein the pressing and forming process, the mixed powder is pressed and formed in an oriented magnetic field, and the magnetic field intensity of the oriented magnetic field is not less than 1.4 T.

10. An NdFeB magnet, wherein the NdFeB magnet is prepared by the preparation method of claim 1.

11. The preparation method according to claim 2, wherein the raw material components of the alloy A comprise 40-60 wt % Re, 0-2 wt % Co, 3-10 wt % Cu, 3-10 wt % Ga, 0-0.5 wt % Nb and/or Zr, 0.5-0.8 wt % B and a balance of Fe.

12. The preparation method according to claim 2, wherein the raw material components of the alloy A comprise: 30-32 wt % Nd, 1.0-2.0 wt % Co, 0.05-0.1 wt % Cu, 0.3-0.8 wt % Al, 0.1-0.15 wt % Ga, 0.12-0.15 wt % Zr, 0.9-0.92 wt % B and the balance of Fe; the raw materials of the alloy B comprise: 40-50 wt % Nd, 1.0-1.5 wt % Co, 5-8 wt % Cu, 0.1-0.4 wt % Al, 5-8 wt % Ga, 0.2-0.3 wt % Nb, 0.65-0.75 wt % B and the balance of Fe; preferably,
the raw material components of the alloy A comprise: 32 wt % Nd, 1.5 wt % Co, 0.1 wt % Cu, 0.8 wt % Al, 0.1 wt % Ga, 0.15 wt % Zr, 0.9 wt % B and the balance of Fe; the raw material components of the alloy B comprise: 50 wt % Nd, 1.0 wt % Co, 6 wt % Cu, 0.4 wt % Al, 6 wt % Ga, 0.3 wt % Nb, 0.75 wt % B and the balance of Fe; or,
the raw material components of the alloy A comprise: 31.5 wt % Nd, 1.5 wt % Co, 0.1 wt % Cu, 0.6 wt % Al, 0.1 wt % Ga, 0.15 wt % Zr, 0.9 wt % B and the balance of Fe; the raw material components of the alloy B comprise: 45 wt % Nd, 1.0 wt % Co, 5 wt % Cu, 0.1 wt % Al, 5 wt % Ga, 0.3 wt % Nb, 0.7 wt % B and the balance of Fe.

13. The preparation method according to claim 2, wherein the sintering treatment has a treatment temperature of 1000-1100° C. and a treatment time of 5-10 h.

14. The NdFeB magnet according to claim 10, wherein the alloy B has a use amount accounting for 1-10% of the weight of the alloy A.

15. The NdFeB magnet according to claim 10, wherein the raw material components of the alloy A comprise: 30-32 wt % Nd, 1.0-2.0 wt % Co, 0.05-0.1 wt % Cu, 0.3-0.8 wt % Al, 0.1-0.15 wt % Ga, 0.12-0.15 wt % Zr, 0.9-0.92 wt % B and the balance of Fe; the raw materials of the alloy B comprise: 40-50 wt % Nd, 1.0-1.5 wt % Co, 5-8 wt % Cu, 0.1-0.4 wt % Al, 5-8 wt % Ga, 0.2-0.3 wt % Nb, 0.65-0.75 wt % B and the balance of Fe; preferably,
the raw material components of the alloy A comprise: 32 wt % Nd, 1.5 wt % Co, 0.1 wt % Cu, 0.8 wt % Al, 0.1 wt % Ga, 0.15 wt % Zr, 0.9 wt % B and the balance of Fe; the raw material components of the alloy B comprise: 50 wt % Nd, 1.0 wt % Co, 6 wt % Cu, 0.4 wt % Al, 6 wt % Ga, 0.3 wt % Nb, 0.75 wt % B and the balance of Fc, or,
the raw material components of the alloy A comprise: 31.5 wt % Nd, 1.5 wt % Co, 0.1 wt % Cu, 0.6 wt % Al, 0.1 wt % Ga, 0.15 wt % Zr, 0.9 wt % B and the balance of Fe; the raw material components of the alloy B comprise: 45 wt % Nd, 1.0 wt % Co, 5 wt % Cu, 0.1 wt % Al, 5 wt % Ga, 0.3 wt % Nb, 0.7 wt % B and the balance of Fe.
